(19) United States
(12) Patent Application Publication
(10) Pub. No.: US 2023/0146250 A1
(43) Pub. Date: May 11, 2023

(54) A COMPOSITE FIBRE STRUCTURE AND THE PROCESS OF MANUFACTURING THEREOF

(71) Applicant: FABHEADS AUTOMATION PRIVATE LIMITED, Kottivakkam (IN)

(72) Inventors: Akshay BALLAL, Semencherry (IN); Abhijeet RATHORE, Churu (IN); Dhinesh KANAGARAJ, Thoraipakkam (IN)

(21) Appl. No.: 17/912,865

(22) PCT Filed: Mar. 22, 2021
(86) PCT No.: PCT/IN2021/050299

§ 371 Date: Sep. 20, 2022

(30) Foreign Application Priority Data
Mar. 20, 2020 (IN) 202041012068

(51) Int. Cl. B29D 99/00; B29C 64/40; B29C 70/68; B29C 70/34; B33Y 10/00; B33Y 40/20; B33Y 80/00

(52) U.S. Cl. CPC B29D 99/0028; B29C 64/40; B29C 70/682; B29C 70/34; B33Y 10/00; B33Y 40/20; B33Y 80/00; B64C 1/00

(57) ABSTRACT

The present embodiment relates to a composite fibre structure (100) and a method (200) of manufacturing the composite fibre structure (200). The composite fibre structure (100) includes a core (102) and an outer layer (108) enclosing the core (102). The core (102) further includes at least one of a permanent core (104) and a temporary core (106). The permanent core (104) is 3-D printed along with the temporary core (106) to form the core structure (102). The permanent core (104) and the temporary core (106) are placed alternatively along the section, extending throughout the length of the composite fibre structure (100), or the permanent core (104) and temporary core (102) can be alternate along the length of the composite fibre structure (100). The layer (108), made of a reinforcement material, wraps the core (102) to form the composite fibre structure (100).

### FIELD OF INVENTION

The present embodiment relates to the field of composite fibre structures, and more particularly relates to composite fibre structures and the method of manufacturing the composite fibre structures by additive manufacturing technique.

### BACKGROUND OF THE INVENTION

The first flight used wood, fabric and waxed twine; and with developing technologies and knowledge of the environment, aviators shifted focus to creating all-metal flights using aluminium or aluminium alloy with fabric covered surfaces. Over time, high-speed aviation produced experimental aircrafts using aluminium alloys with advanced carbon composites, silicon carbide ceramic coatings, titanium-aluminium alloys and titanium alloys reinforced with ceramic fibres to mitigate the effects of aerodynamic heating.

Recently, focus has shifted to make flights stronger, safer, and lighter—in turn making them more fuel-efficient, welcoming the use of composite materials in aviation. Composite structures are load-bearing elements (e.g., stiffeners, panels, shells, etc.) fabricated from materials that are typically non-metallic non-homogeneous combinations of fibres and resins.

With the virtues of composite structure typically including reduced weight, increased performance, and fuel economy; fibreglass was used in flights, eventually paving way for the use of fibre-reinforced resin matrices with resins like polyester, vinyl ester and epoxy reinforced with fibres such as glass, carbon or boron.

In aviation, a propeller is a device having a rotating hub and a number of radiating blades placed evenly around the hub. The propeller is used to convert rotational energy into a propulsive force, thereby enabling propelling of the aircraft.

Traditionally, the propeller blades are made from alloys of aluminium and stainless steel. However, metal blades are now replaced with the composite fibre structures, having numerous advantages vis-à-vis lighter, corrosion resistant, increased durability and decreased vibration.

Typically, the composite fibre structure includes a stiffener for providing sufficient stiffness and for resisting vibrational forces. The presence of stiffeners makes the manufacturing of the composite fibre structure complicated due to difficulty in their in-situ fabrication and proper alignment. One of the techniques for in-situ fabrication includes injection of the resin into the reinforcements. The process requires a sealant, thereby making the process of manufacturing composite fibres more complicated and expensive.

Currently, there exists a technique for the manufacturing of the composite fibre structures via additive manufacturing techniques but these are only for manufacturing the outer skin by laying layers of composite material onto a mould. This process cannot be used for making the inner core structure.

Additionally, the currently existing techniques for manufacturing composite fibre structures place stiffeners separately within the composite fibre structure, making the alignment of stiffeners increasingly difficult, and requiring additional fixtures for the same.

Therefore, in light of the above-mentioned limitations of the existing composite structures, there exists a need of a composite fibre structure which is manufactured in-situ and fabricated with the internal core structure therein. More particularly, there exists a need to eliminate traditional composite structures for the difficulty in designing and manufacturing the same, and need for utilising additional fixtures or sealants in order to hold the shape of the composite fibre structure, for improved aerodynamics.

### SUMMARY OF INVENTION

In light of the limitations of the existing conventional systems as discussed above, it is evident that there arises a need for an efficient composite fibre structure which is manufactured in-situ and fabricated with the internal core structure therein in order to substantially overcome the above-mentioned limitations.

The present disclosure portrays a reduction in the overall weight of the flight by providing use of a composite fibre structure, making it lighter, corrosion-resistant, and increasing the durability and decreasing the vibration being caused in the flight. Another object of the present disclosure is to provide an uncomplicated or simple arrangement of the stiffener via in-situ fabrication and alignment of the stiffener in the composite fibre structure.

Yet another objective of the present invention is to mitigate the requirement of additional fixtures or sealants for holding the shape of the composite fibre structure, making it comparatively inexpensive to the presently existing composite fibre solutions, while retaining structural integrity.

Yet another object of the present invention is to provide a process of manufacturing composite fibre structures using additive manufacturing, or three-dimensional printing of the entire core using continuous fibre printing and soluble core materials.

Yet another object of the present invention is to provide a process of manufacturing composite fibre structures using additive manufacturing, or three-dimensional printing, wherein the core can be manufactured in any shape, including but not limited to a honeycomb or a truss, having varying stiffness across the span and chord.

Yet another object of the present invention is to provide a composite fibre structure wherein once the core is manufactured of the desired cross section, the layup can be performed on top of the composite fibre structure, and the soluble material can be dissolved post the curing process.

In an aspect, embodiments of the present disclosure provide a composite fibre structure. The composite fibre structure includes a core (102) and a layer (108) enclosing the core (108). Further, the core (102) includes a permanent core (104) and a temporary core (106). Either or both of the permanent core (104) and temporary core (102) may be printed. For example, say, once permanent core is printed, the temporary core may simply be filled in the gaps. The permanent core (104) and the temporary core (106) are placed alternatively along the section, extending throughout the length or partial length/dimensions of the composite fibre structure (100). The layer (108), made of a reinforcement material, wraps the core (102) to form the composite fibre structure (100).

### BRIEF DESCRIPTION OF THE DRAWINGS

Other objects, features, and advantages of the embodiment will be apparent from the following description when read with reference to the accompanying drawings. In the drawings, wherein like reference numerals denote corresponding parts throughout the several views:

FIG. 1 illustrates a cross-section of a composite fibre structure (100), according to an embodiment herein;

FIG. 1B illustrates a permanent core of the composite fibre structure in a sinusoidal or zigzag shape, according to an embodiment herein;

FIG. 1C illustrates a permanent core of variable stiffness placed along the composite fibre structure, according to an embodiment herein;

FIG. 1D illustrates permanent and temporary cores placed intermittently along the span of the composite fibre structure, according to an embodiment herein;

FIG. 2 illustrates a method (200) of manufacturing the composite fibre structure (100), according to an embodiment herein;

FIG. 2A illustrates a composite fibre structure placed inside a vacuum bag having a vacuum port, according to an embodiment herein;

FIG. 2B illustrates a composite fibre structure pressurised using a compressing die, according to an embodiment herein;

FIG. 3 illustrates a rotary wing craft (300) having the composite fibre structure (100), according to an embodiment herein;

FIG. 4 illustrates an aircraft (400) having the composite fibre structure (100), according to an embodiment herein;

FIG. 5 illustrates an aircraft (500) having the composite fibre structure (100), according to an embodiment herein; and

FIG. 6 illustrates a multi-rotor UAV (600) having the composite fibre structure (100), according to an embodiment herein.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Embodiments of the present disclosure provide a composite fibre structure and a method of manufacturing the composite fibre structure, wherein the composite fibre structure includes a core, and an outer layer enclosing the core. The composite fibre structure is prepared by additive manufacturing, such that the entire core is prepared by way of three-dimensional printing.

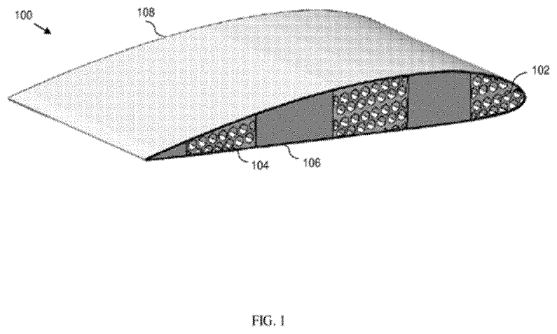

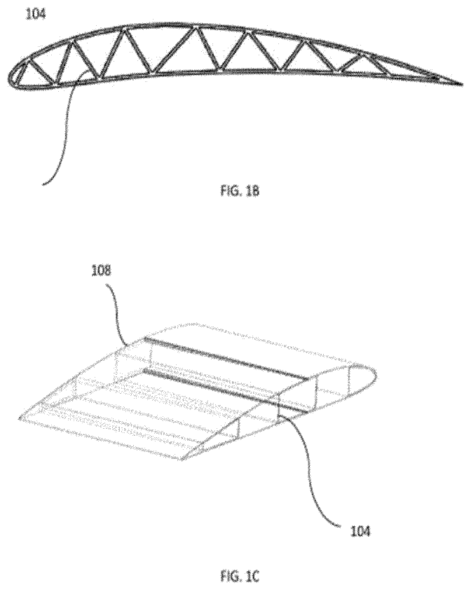

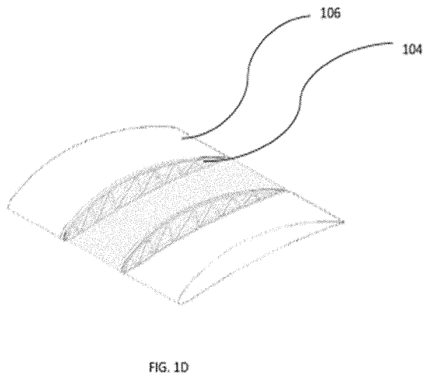

Referring to FIG. 1, the figure illustrates a cross-section of the composite fibre structure (100), according to an embodiment herein. The composite fibre structure includes a core (102) and a layer (108) enclosing the core (102). The core (102) further includes a permanent core (104) and a temporary core (106). In an embodiment, the permanent core (104) is the core that is printed to be permanently fitted inside the layer 108 whereas the temporary core (106) is removed. In an embodiment, the temporary core may be removed at the manufacturing site of the composite fibre structure. In a preferred embodiment, the temporary core (106) is removed at the site of deployment. The temporary core (106) may be left to remain inside the layer so as to help stability of the structure during transit and storage.

According to an embodiment, the permanent core (104) is a multi-layered structure formed by 3-D printing using 3-D printers. In an aspect of the present embodiment, the term “3-D printing” refers to the process of manufacturing a 3-dimensional object by successively stacking multiple layers of material. The permanent core (104) is 3-D printed by using a reinforcement material. The reinforcement material can also be paired with other functional fibers like optical fiber, nichrome wire. In an embodiment, the reinforcement material includes, but not limited to, carbon fibre, fibreglass and aramid fibre, impregnated with a resin.

In another aspect of the present embodiment, the resin material includes, but is not limited to thermoplastic materials for example Nylon, and ABS, and thermoset material like Epoxy. In a preferred embodiment, the reinforcement material is carbon fibre. In another preferred embodiment, the resin material is a thermoplastic material. The permanent core forms the main load carrying element of the structure. In an embodiment, permanent core can be of any shape and size based on the strength and stiffness requirements of the complete composite fiber structure. In an aspect of the present embodiment, the permanent core (104) is of variable thickness and stiffness along the length of the composite fibre structure (100).

In yet another aspect of the present embodiment, the temporary core (106) is made of a temporary material including, but not limited to, like polyvinyl alcohol, high-impact polystyrene, or a wax that can be either dissolved using a solvent or melted away easily. The temporary core may either be 3D printed or be filled in. The temporary core provides a surface for the layup of outer skin and holds the permanent structural core together. In a preferred embodiment, a solvent is added to the composite fibre structure (100) for dissolving the temporary material present inside the temporary core (106) at the end of the fabrication process. The removal of the temporary material leads to the removal of excess material such that only the essential structural core remains, along with outer skin. In an embodiment, the permanent core (104) and the temporary core (106) are placed throughout the cross section of the core (102). In an embodiment, the temporary core is filled or 3D printed in the gaps left by permanent core or by placement of permanent core inside the layer.

In yet another embodiment, the core (102) is enclosed by the layer (108). The layer (108) is a thin sheet-like structure made of the reinforcement material. In an embodiment, the reinforcement material includes, but not limited to, carbon fibre, fibreglass and aramid fibre. In a preferred embodiment, the layer (108) enclosing the core (102), is made of carbon fibre. In an aspect of the present embodiment, the layer (108) enclosing the core (102) is of variable thickness along the span of the structure. FIG. 1D illustrates the placement of the permanent and temporary cores along the span of the structure.

Referring to FIG. 1B, in yet another embodiment, the core (102) is made up of a permanent core (104), which is in a wave or sinusoidal shape. This shape provides a good balance between stiffness and is lightweight for the composite fiber structure.

Referring to FIG. 1C, in yet another embodiment, the core (102) is made up of a permanent core (104) that has a variable thickness along the span of the composite fiber structure. This configuration provides a variable stiffness along the span, and hence gives a lighter overall structure.

As may be surmised, the shape or configuration of the permanent core may be altered depending on the requirement.

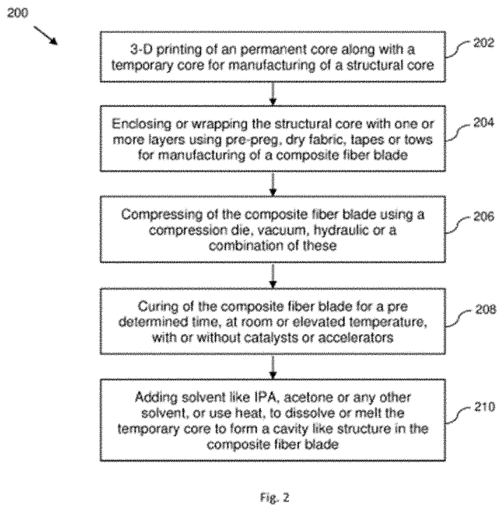

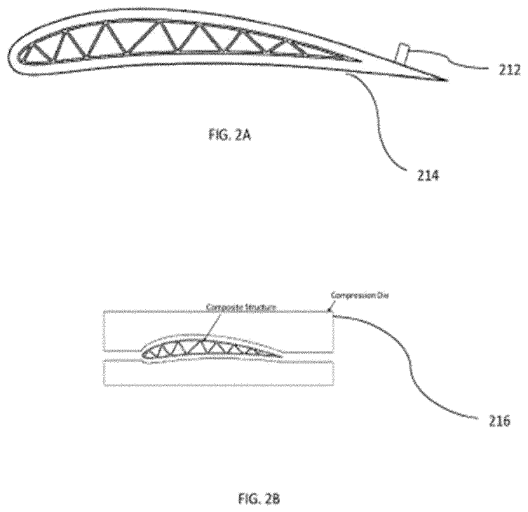

Referring to FIG. 2, the figure illustrates the method (200) for manufacturing the composite fibre structure (100), covering the various steps for manufacturing the composite fibre structure (100) initiating at step 202, where the permanent core (104) is printed in a three-dimensional manner along with the temporary core (106) to form the core (102) of the composite fibre structure (100).

In an embodiment of the present invention, the multiple layers are printed successively over one another to form the multi-layered core (102). In an aspect of the present embodiment, the permanent core (104) is 3-D printed by using reinforcement material including but not limited to carbon fibre, fibreglass and aramid fibre. In a preferred embodiment, the reinforcement material is carbon fibre. In another aspect of the present embodiment, the temporary core (106) is made of a temporary material including but not limited to Polyvinyl Alcohol. In an embodiment, the permanent core (104) and the temporary core (106) are placed across the complete cross section of the structure. The temporary core allows the permanent core to be held in precise location and also provides a suitable surface for the following skin-layup step.

Further, at step 204, the layer (108) encloses the core (102) using a skin-layup method including but not limited to hand layup method, automatic tape layup (ATL) or automatic fibre placement (AFP). In an embodiment of the present invention, the layer (108) enclosing the core (102) is made of the reinforcement material including but not limited to carbon fibre, fibreglass and aramid fibre. In a preferred embodiment, the reinforcement material is carbon fibre.

At step 206, the composite fibre structure (100) obtained from the step (204) is compressed using a compression die 216 as shown in FIG. 2B. Compression method may utilize a die compressed against the composite structure using hydraulics, vacuum assistance or high-pressure autoclaving. Compression method can also utilize a bag compressed using hydraulics, vacuum assistance or high-pressure autoclaving. Moreover, the compression die (214) can also be heated in order to assist curing of composite, or assist in compression, or both FIG. 2A illustrates the composite structure enclosed in a vacuum bag 214 having a vacuum port 212.

In an embodiment of the present invention, the compression die is used for compressing the composite fibre structure (100) for the desired shape and surface finish.

Furthermore, at step 208, the composite fibre structure (100) is cured for a predetermined time. In an embodiment, the term “curing” as used herein, refers to the process employed for the toughening/hardening of the 3-D printed composite fibre structure (100).

At step 210, the temporary core is removed. In an embodiment, if the temporary core is made using soluble material, a solvent is added to the composite fibre structure (100). In another embodiment, if the temporary core is made with material having low melting point, the structure is heated to melt away the temporary core. In an embodiment of the present invention, the solvent dissolves the temporary materials present in the temporary core (106). The dissolving away of the temporary material leaves behind the permanent structural core (104) and the skin (108) of the composite fibre structure (100). In an embodiment, step 210 is performed at the manufacturing site, before transport and delivery. In yet another embodiment step 210 is performed after transport. In this embodiment, the temporary core supports the structure during transit and can be dissolved or melted away right before deployment.

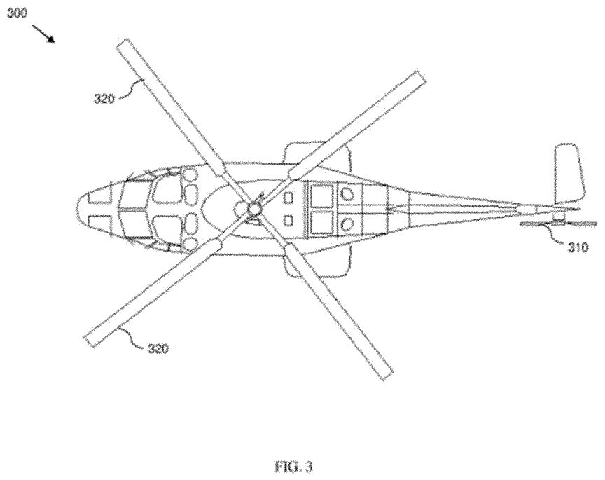

Referring to FIG. 3, the figure illustrates a rotary wing craft (300) having the composite fibre structure (100), according to an embodiment herein. The rotary wing craft (300) includes a tail rotor blade (310), and a main rotor blade (320). In an aspect of the present embodiment, the tail rotor blade (310) and the main rotor blade (320) are made up of the composite fibre structure (100). The rotary wing craft (300) further includes additional components including but not limited to a cabin, an airframe, a plurality of landing gear, a power-plant, and a transmission.

In another aspect of the present embodiment, the rotary wing craft (300) portrays multiple configurations of a rotary wing craft, including but not limited to single-rotor and dual-rotor helicopters, a transverse rotor craft or a TurboProp aircraft. In yet another aspect of the present embodiment, the rotary wing craft (300) includes either the tail rotor blade (310), or the main rotor blade (320). In another aspect of the present embodiment, the rotary wing craft (300) includes a plurality of the tail rotor blade (310), or a plurality of the main rotor blade (320), or a plurality of both—the tail rotor blade (310) and the main rotor blade (320). In an embodiment, as may be understood, this present embodiment find applications in all kind of propellers and turbine blades apart from applications in structure or chassis component that may be envisaged.

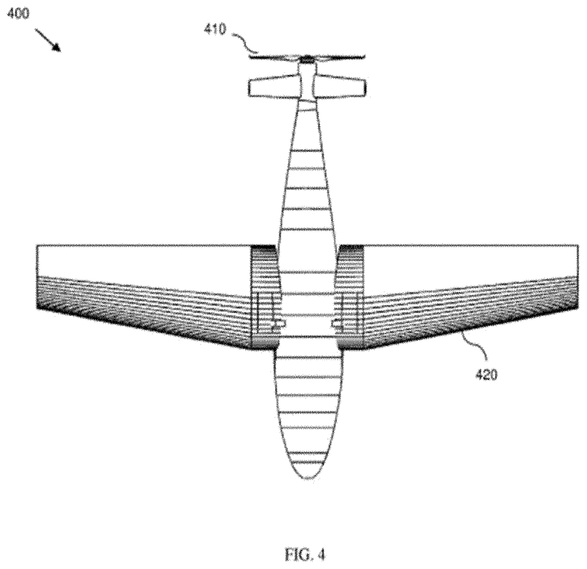

Referring to FIG. 4, the figure illustrates an aircraft (400) having the composite fibre structure (100), according to an embodiment herein. The aircraft (400) includes a fixed wing aircraft propeller (410) and a fixed wing aircraft wing (420). In an aspect of the present embodiment, the fixed wing aircraft propeller (410) and the fixed wing aircraft wing (420) are made up of the composite fibre structure (100). The aircraft (400) further includes additional components including but not limited to a fuselage, a plurality of wings, a cockpit, an engine, a propeller, a tail assembly, and a plurality of landing gear.

In another aspect of the present embodiment, the fixed wing aircraft propeller (410) may be in a plurality of configurations including but not limited to a push configuration or a pull configuration. In yet another aspect of the present embodiment, the aircraft (400) includes either the fixed wing aircraft propeller (410), or the fixed wing aircraft wing (420). In another aspect of the present embodiment, the aircraft (400) includes a plurality of fixed wing aircraft propeller (410), or a plurality of the fixed wing aircraft wing (420), or a plurality of both—the fixed wing aircraft propeller (410) and the fixed wing aircraft wing (420).

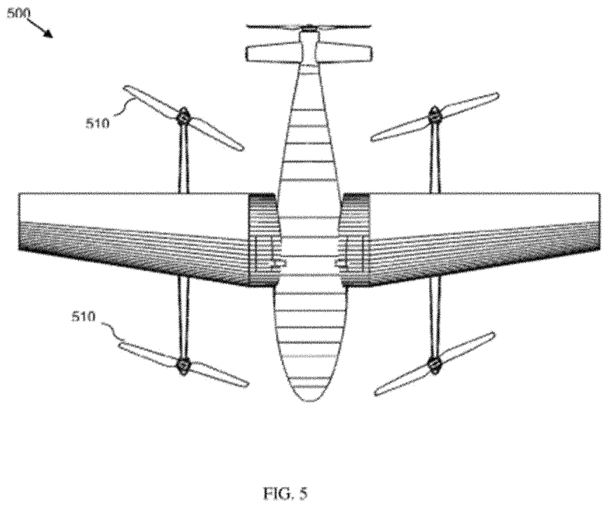

Referring to FIG. 5, the figure illustrates an aircraft (500) having the composite fibre structure (100), according to an embodiment herein. The aircraft (500) includes a hybrid fixed drone propeller (510). In an aspect of the present embodiment, the hybrid fixed drone propeller (510) is made up of the composite fibre structure (100). The aircraft (500) further includes additional components including but not limited to a fuselage, a plurality of wings, a cockpit, an engine, a propeller, a tail assembly, and a plurality of landing gear. In another aspect of the present embodiment, the aircraft (500) includes a plurality of the hybrid fixed drone propeller (510).

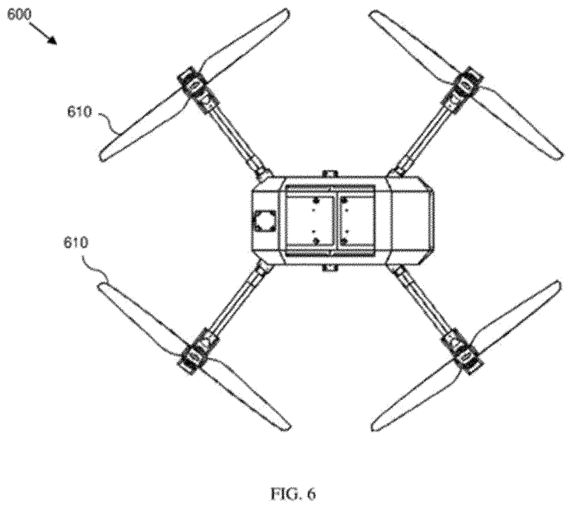

Referring to FIG. 6, the figure illustrates a drone (600) having the composite fibre structure (100), according to an embodiment herein. The drone (600) includes a multi-rotor propeller (610). In an aspect of the present embodiment, the multi-rotor propeller (610) is made up of the composite fibre structure (100). The drone (600) further includes additional components including but not limited to a frame, a plurality of motors, an electronic speed controller, a battery, a flight controller, and a receiver. In another aspect of the present embodiment, the drone (600) includes a plurality of the multi-rotor propeller (610). In another aspect of the present embodiment, the multi-rotor propeller (610) is utilised for a plurality of configurations including but not limited to a single propeller or coaxial configuration on each motor, making the overall configuration of the drone (600) including but not limited to a tri-copter, a quad-copter, a hex-copter or an oct-copter.

The composite fibre structure (100) and the method (200) for manufacturing the composite fibre structure (100) as provided herein, is durable, corrosion resistant and cost effective. In an embodiment of the present invention, the composite fibre structure (100) are designed for use with, but not limited to, aircrafts, turbines and marine ships.

As will be readily apparent to a person skilled in the art, the present invention may easily be produced in other specific forms without departing from its essential composition and properties. The present embodiments should be construed as merely illustrative and non-restrictive and the scope of the present invention being indicated by the claims rather than the foregoing description, and all changes which come within therefore intended to be embraced therein.

I/We claim:

1. A composite fibre structure (100), comprising
one or more permanent cores of varying shapes core (102), and
a skin layer (108);
wherein the skin layer (108) encloses the core.

2. The composite fibre structure (100) as claimed in claim 1, further comprising at least at least one temporary core (106) that may be removed,
wherein the temporary core is filled or 3D printed in gaps of the structure (100) or of the permanent core (104);
wherein the permanent core (104) and the temporary core (106) are printed in a three dimensional manner to formulate the core (102).

3. (canceled)

4. (canceled)

5. The composite fibre structure (100) as claimed in claim 2, wherein the permanent core (104) and the temporary core (106) are of any shape or size within the cross-section;
wherein the permanent core (104) and the temporary core (106) are of variable shape or size along the span of the structure;
wherein the permanent core (104) and temporary core (102) are placed alternately along the span of the structure;
wherein the permanent core (104) is comprised of reinforced material impregnated with resin.

6. (canceled)

7. (canceled)

8. (canceled)

9. (canceled)

10. (canceled)

11. (canceled)

12. (canceled)

13. A method (200) for manufacturing a composite fibre structure (100), the method comprising
printing a permanent core (104) and a temporary core (106) for forming a core (102) of the composite fibre structure (100);
enclosing the core (102) in a layer (108) for forming the composite fibre structure (100);
compressing the composite fibre structure (100) utilising a compression method;
curing the composite fibre structure (100) for a predetermined time; and
adding a solvent to the composite fibre structure (100);
wherein the permanent core (104) and the temporary core (106) are alternately arranged in layers for forming the core (102) of the composite fibre structure (100).

14. The method (200) for manufacturing the composite fibre structure (100) as claimed in claim 13, wherein the permanent core (104) is comprised of reinforcement material impregnated with resin.

15. The method (200) for manufacturing the composite fibre structure (100) as claimed in claim 13, wherein the permanent core (104) and the temporary core (106) can be made of any shape or size within the cross-section.

16. The method (200) for manufacturing the composite fibre structure (100) as claimed in claim 13, wherein the permanent core (104) and the temporary core (106) can be made of variable shape or size along the span of the structure.

17. The method (200) for manufacturing the composite fibre structure (100) as claimed in claim 13, wherein the temporary core (106) is comprised of temporary material.

18. The method (200) for manufacturing the composite fibre structure (100) as claimed in claim 13, wherein the solvent dissolves temporary material comprised in the temporary core (106), thereby retaining only the permanent core (104) and the layer (108) of the composite fibre structure (100).

19. The method (200) for manufacturing the composite fibre structure (100) as claimed in claim 13, wherein the predetermined time required for curing the composite fibre structure (100) is based on the materials and shape chosen for the core (102) including the permanent core (104) and the temporary core (106), and the layer (108).

20. The method (200) for manufacturing the composite fibre structure (100) as claimed in claim 13, wherein the layer (108) is made utilizing an automated system or a hand layup.

21. The method (200) for manufacturing the composite fibre structure (100) as claimed in claim 13, wherein the compression method utilizes a die compressed using hydraulics, vacuum assistance or high pressure autoclaving.

22. The method (200) for manufacturing the composite fibre structure (100) as claimed in claim 13, wherein the compression method utilizes a bag compressed using hydraulics, vacuum assistance or high pressure autoclaving.

23. The method (200) for manufacturing the composite fibre structure (100) as claimed in claim 13, wherein the compression method utilizes a die which is heated in order to assist curing of composite, or assist in compression, or both.

24. A composite fibre structure (100) provided to be manufactured in-situ, the composite fibre structure comprising a core (102) and a layer (108), the method comprising
printing a permanent core (104) and a temporary core (106) for forming the core (102) of the composite fibre structure (100);
enclosing the core (102) in the layer (108) for forming the composite fibre structure (100);
compressing the composite fibre structure (100) utilising a compression die;
curing the composite fibre structure (100) for a predetermined time; and
adding a solvent to the composite fibre structure (100);
wherein the permanent core (104) and the temporary core (106) are alternately arranged in layers for forming the core (102) of the composite fibre structure (100).

25. The composite fibre structure (100) as claimed in claim 23, wherein the permanent core (104) is comprised of reinforced material impregnated with resin.

26. (canceled)

27. The composite fibre structure (100) as claimed in claim 23, wherein the solvent dissolves temporary material comprised in the temporary core (106), thereby retaining only the permanent core (104) of the composite fibre structure (100).

28. The composite fibre structure (100) as claimed in claim 23, wherein the predetermined time required for curing the composite fibre structure (100) depends on the materials chosen for the core (102) including the permanent core (104) and the temporary core (106), and the layer (108).
